(19) United States
(12) Patent Application Publication
(10) Pub. No.: US 2022/0252271 A1
(43) Pub. Date: Aug. 11, 2022

(54) SILICON NITRIDE MELT

(71) Applicant: Electrolux Home Products, Inc., Charlotte, NC (US)

(72) Inventors: Michael Dennis Padgett, Springfield, TN (US); Brian Martin, Nashville, TN (US); John Ballman, Cottontown, TN (US); Catherine L. May, Springfield, TN (US)

(21) Appl. No.: 17/169,313

(22) Filed: Feb. 5, 2021

(51) Int. Cl. F24C 1/04; H05B 3/14; F24C 7/06

(52) U.S. Cl. CPC F24C 1/04; F24C 7/067; H05B 3/148

(57) ABSTRACT

A burner assembly is disclosed including a burner head for generating heat via an electrical heating element and an annular burner head surrounding the burner head for generating heat via the burning of a gas/air mixture. The burner head may be used for simmering with the electrical heating element including a silicon nitride element for generating the low heat required for simmering. The annular burner head may be used for generating more heat than the burner head.

### BACKGROUND OF THE INVENTION

The present disclosure generally relates to gas burners as may be applied in appliances such as hobs, cooktops, stoves and the like, the gas burners being a source for heating a utensil during a cooking process. In particular, the present disclosure relates to particularly configured gas burners wherein high cooking heat is generated from gas and low or simmering heat is generated by electricity. The simmering heat may be generated in a burner head and radiated outwards from a burner head cap with the high heat being generated by an annular burner head surrounding the burner head.

Traditional gas burners generate heat by the burning of a gas/air mixture wherein generation is in direct correlation to the amount of air/gas mixture supplied to and ignited at the burner. For example, a gas stove burner generally comprises a burner assembly attached to a small gas valve that is further connected to a main gas line. An intake valve for physical articulation is provided for the control of gas flow from the main gas line eventually into the burner oftentimes passing through a venturi tube comprising a wide pipe with a narrow section followed by a wider section. Small air holes are provided in the wider section so that when the gas passes through the narrow section, it undergoes an increase in pressure which is subsequently released as the gas leaves the narrow section for the wider section. The release causes air to be sucked into the wider section through the small air holes. The resulting gas/air mixture is combustible (with a particular heat) and flows into the burner for eventual ignition which generates a flame for heating. Other means for providing the gas/air are known in the art.

Generally, the gas stove burner comprises a hollow metal disk with holes or ports punctured through its perimeter. A pilot, gas or electric driven element resides along the gas/air mixture flow so as to selectively generate a spark which causes the mixture to ignite. Heat generation may be directly dependent upon gas flow and the burning thereof, namely, an increase of the gas flow causes an increase in the heat being generated. Heat generation is generally measured in British Thermal Units (BTU) which is defined as a unit of heat or the amount of heat required to raise the temperature of one pound of water by one degree Fahrenheit.

The level of heat generation required for cooking varies with the variety of receipts and cooking styles being undertaken by the user of the gas stove burner and may for example fall into a range between a high heat output of about 18,000 BTU/hr to a low heat output of about 1,800 BTU/hr. Other heat range end points are known in the art. Applications for low heat output include gently simmering or holding food, with the simmering being the maintaining of the food in a liquified state at just below its boiling point. Examples of such food may include chocolate or butter, which, if brought to a boil or beyond would promptly burn and thereafter spoil.

For a number of reasons, gas burners struggle to maintain and/or arrive at a low heat output needed for simmering food via the burning of the gas/air mixture due, in part, to the requirements for maintaining such a low flame. For example, low flames are per se susceptible to being easily extinguished from ambient air current and the like. While cycling a gas burner by way or re-ignition has been proposed as a possible solution to the aforementioned, such has been found to be expensive to implement and operate.

Other proposed solutions include introducing a second smaller gas burner cooperating within a larger one, the smaller burner being used exclusively for generating only a small flame which may be used alone for simmering or together with larger flames for generating a high heat output. However, the problem of air current extinguishing at least the small burner flames remain. Likewise, the generation of small flames requires maintaining a certain amount of BTU in order to maintain a sufficiently hot flame in order to continue burning the mixture. By way of example, for low temperatures in a typical 3-inch burner, the burning of the gas/air mixture in each port must be maintained. While the percentage of gas flow may be decreased, a certain minimum amount is still required in order to maintain the sufficient amount of heat required to burn the gas/air mixture. Such limits the heat output of the typical 3-inch burner to around 1500 BTUs. Should a still further reduced heat be desired, for example, 1000 BTUs or less, an insufficient amount of heat to maintain the burning of the gas/air mixture would ensue with the result being the respective flame snuffing itself out.

Still other proposed solutions include introduction of other heat generating means into the burner assembly including electrically generated heat sources such as from radiant coil elements. However, radiant elements draw a significant amount of current, which at times may exceed that available within the appliance, and require an inordinate amount of time to generate the low heat thereby making their use impractical.

An additional limitation on the generation of low heat includes use of certain safety measures such as flame sensors and thermocouples, wherein current is generated in response to the presence of a flame (former) or absence of a flame (latter). Depending upon configuration, such current is used as a safety feature to cut off the flow of gas, typically via an appropriately configured and arranged solenoid, thereby preventing release and potential hazardous buildup of gas. Here too, a typically lowest setting achievable for heat generation is about 1500 BTUs before a safety feature becomes active.

The aforementioned have yielded another proposed solution for the user intended to simmer foodstuff in a utensil, namely, the manually displacing of the utensil being simmered so as to limit the amount of heat received in any one location therein. Such solution includes the drawback of requiring specialized training from the user which may, for example, only be acquired from a certain skill set and/or trial and error experience. Additionally, such requires a certain time and attention commitment oftentimes in short supply in the kitchen. As such, this solution is per se not suitable for many users, applications and/or environments.

An example solution of providing other heat generating sources may be found in US 2005/0076899 which discloses a burner assembly 14 having a gas sub-assembly 16 and radiant heat sub-assembly 18. The gas sub-assembly 16 includes a gas burner head 32 defining ports 44 through which flames for heat generation emerge, the flames being the product of an ignited gas/air mixture arriving into the gas burner head 32 via chamber 34. This heat generation is primarily targeted at the higher range of manually selectable desired heat generation alone or in combination with the radiant heat sub-assembly 18. For low heat generation only, the radiant heat sub-assembly 18 may be employed. The subassembly includes a number of radiant heat sources 24 which may be covered in an infrared permeable protective layer and comprise ribbon heaters which are known flexible resistive heating elements. With current passing through the ribbon heaters, the resistive heat is generated. The resulting heat generated by the radiant heat sources 24 pass upwards through a radiant heat transmissive cover 30. While offering a hybrid solution to heat generation, the proposed solution introduces complexities of design and cost hindering its implementation. Additionally, ribbon heating elements tend to be brittle and subject to breakage. Likewise, the resistive heating elements require time to heat up and may draw a significant amount of current in the process of doing so.

Another hybrid solution is set out in US 2017/0138603 wherein a resistive heating element 28, 128, 180 is/are arranged below burner housing 16 from which gas ignited flames emanate, via outlet 22, for heating an area above central region 24. The heating element(s) are intentionally positioned below the burner housing so as to heat up air flowing through an outlet 52 and heated air path 48. Accordingly, it is the distribution of hot air which affects delivery of the low heat generation atop the central region 24. The heating element(s) may comprise any suitable resistance-based material configured to generate the equivalent of about 500 BTU/hr upon provision of 150 Watts. While also offering a hybrid solution to heat generation, the proposed solution introduces complexities of design and cost thereby hindering its implementation. Likewise, here too, the heating element(s) are hindered by way of heat up time and current required for the same. Still further, this design impacts the heat generation and delivery efficiency by locating the heat source further away from the heated target than other such arrangements.

Accordingly, a need exists in the art for the delivery of low heat for simmering, the delivery being relatively quick and inexpensive to operate while limiting the aforementioned complexities and disadvantages. Such delivery should further be both safe and robust. Design flexibility is also a consideration for attaining good heat transfer efficiency between heat source, any intervening cap and utensil placed above the central region of the burner.

### SUMMARY OF THE INVENTION

It is an object of the present disclosure to provide a hybrid burner assembly configured to generate select heat from at least one of a gas/air mixture and electricity. In particular, heat, such as high heat, generated from the gas/air mixture may be obtained from burning the same thereby generating a flame of a particular size emanating from a gas stove burner arrangement upon which a utensil to be heated sits. Additionally, heat, such as low or simmering heat, generated from electricity arises from passing a current through a silicon nitride element arranged below a central cap of the gas stove burner, akin to a hot surface igniter, such that heat radiates outward from the cap towards the utensil.

Silicon nitride as a material provides certain benefits making selection of this material for use herein particular advantageous. Such advantages stem from safety and performance. Benefits of using silicon nitride include the materials physical robustness and electrical insulation. By virtue of the former, silicon nitride may withstand potential manual or physical shocks to which certain kitchen appliances may typically be subjected in the course of normal use. By virtue of the latter, the silicon nitride element may be safe to the touch, assuming it is or has cooled, and the surround material about the silicon nitride element, along with any other material which may potentially come into contact therewith, need not be grounded. Such provides various design flexibilities and cost advantages.

A still further advantage is that with silicon nitride a limited amount of amperage, as compared with a typical radiant rod, is required to attain a sufficient amount of heat generation in order to convey a low or simmering heat to the utensil. The silicon nitride element requires about 0.5 amperes to operate which is a faction of that required by the typical radiant rod. Likewise, the silicon nitride becomes hotter faster than the typical radiant rod. Accordingly, radiant rods do not offer the same heat performance or operational cost as the instant silicon nitride element.

Particular burner controls, arranged for example in a single activation point, may be included facilitating particular uses, such as delivering gas/air mixture to a burner arranged and configured to deliver high amounts of heat while keeping the silicon nitride element deactivated; and oppositely, cutting off the gas/air mixture while activating the silicon nitride element for delivering the low or simmering heat. Such controls may include a selector switch or knob conveniently arranged near the burners and configured to turn on and off the aforementioned accordingly. Additional embodiments may include use of temperature sensors, appropriately arranged in communication with the controls and configured to provide feedback for maintaining a particular heat output as well as provide additional safety features and the like.

### BRIEF DESCRIPTION OF THE SEVERAL VIEWS OF THE DRAWINGS

Further advantages features and details of the various embodiments of this disclosure will become apparent from the ensuing description of a preferred exemplary embodiment or embodiments and further with the aid of the drawings. The features and combinations of features recited below in the description, as well as the features and feature combination shown after that in the drawing description or in the drawings alone, may be used not only in the particular combination recited but also in other combinations on their own without departing from the scope of the disclosure.

In the following, advantageous examples of the invention are set out with reference to the accompanying drawings, wherein:

FIG. 1 depicts an example multi-ring burner with covers;

FIG. 2 depicts the example multi-ring burner without covers;

FIG. 3 depicts a silicon nitride element accommodated within a burner according to embodiments of the present disclosure; and

FIG. 4 depicts a stand-alone silicon nitride element which may be employed according to embodiments of the present disclosure.

### DETAILED DESCRIPTION OF THE INVENTION

As used throughout the present disclosure, unless specifically stated otherwise, the term “or” encompasses all possible combinations, except where infeasible. For example, the expression “A or B” shall mean A alone, B alone, or A and B together. If it is stated that a component includes “A, B, or C”, then, unless specifically stated otherwise or infeasible, the component may include A, or B, or C, or A and B, or A and C, or B and C, or A and B and C. Expressions such as “at least one of” do not necessarily modify an entirety of the following list and do not necessarily modify each member of the list, such that “at least one of “A, B, and C” should be understood as including only one of A, only one of B, only one of C, or any combination of A, B, and C. In the figures, the same or functionally identical elements have been provided with the same reference signs.

By way of a first embodiment, the present invention will be described with respect to an application to a multi-ring burner without limitation to application to other types and/or configurations of burners.

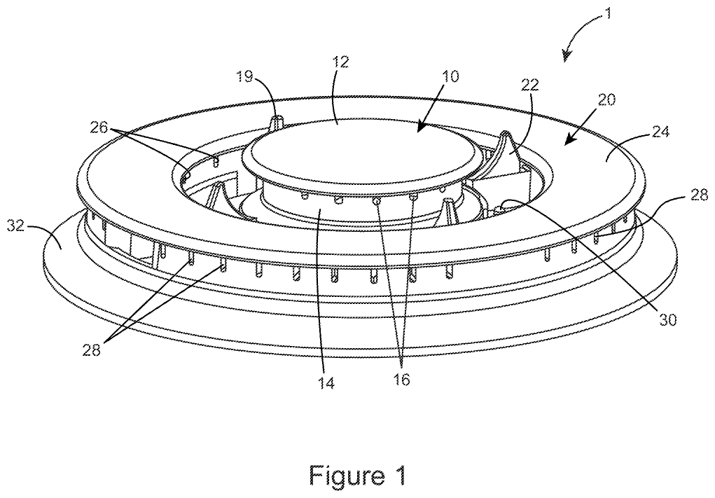

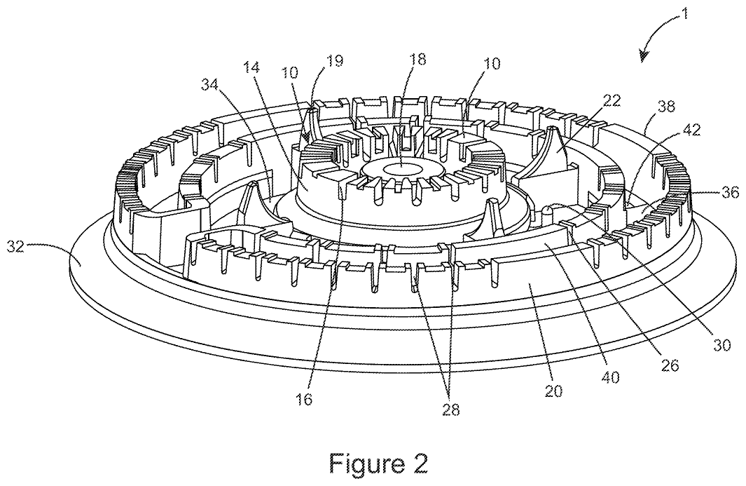

FIG. 1 depicts an example multi-ring burner with covers, the central cover of which may be heated. As shown an inner burner head 10, covered by a central cap or cover 12 is arranged at a center of the multi-ring burner 1. Peripheral wall 14 of the inner burner head 10 includes ports or openings 16 along its' circumference configured to allow for passing of a gas/air mixture provided from within a central opening 18 (FIG. 2) located within the peripheral wall 14 below cap 12. An electric ignition member 19 is positioned to provide ignition to the gas/air mixture passing through openings 16. An outer burner head 20 is arranged in place around or surrounding the inner burner head 10 via the aid of fingers 22. An annular cover 24 is arranged over the outer burner head 20. As depicted, the annular outer burner head 20 includes two gas rings (FIG. 2), one on the inside as defined by second ports or openings 26 and one on the outside as defined by third ports or openings 28. The two gas rings include an appropriately configured and arranged thermopile 30 to ignite the gas/air mixture passing through the second and third openings. An annular skirt 32 is also provided surrounding the multi-ring burner under which a primary air source for mixing with gas to be burned by the multi-ring burner may enter into the multi-ring burner body.

FIG. 2 depicts the inner multi-ring burner 1 of FIG. 1 without the covers 12 and 24. As shown, the inner burner head 10 includes the central opening 18 within its peripheral walls 14. The gas/air mixture may be provided through the central opening 18 into the inner burner head 10 below cap 12 so as to pass outside via the ports or passages 16 for ignition by the electric ignition member 19. Such provides a first heat source for cooking which, given its relative size and position, would typically be reserved for the delivery of low heat. A wall 34 separates the inner and out burner heads. The outer burner head 20 includes a passage 36 defined by concentric walls 38 and 40. Gas/air mixture is introduced through opening 42 in passage 36, the mixture then escaping the passage 36, by virtue also of annular cover 24, via the second and third ports or passages 26 and 28, for ignition by thermopile 30.

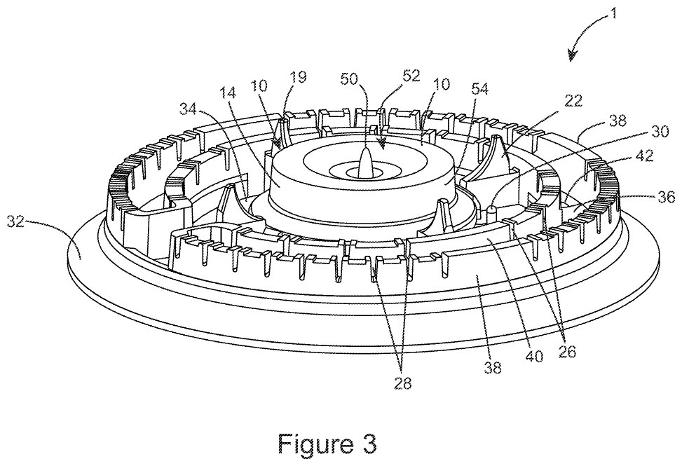

Use of a silicon nitride heating element, such as a silicon nitride element for the generation of low heat below the central cap is depicted in FIG. 3 which shows a multi-ring burner with covers removed. Application of the silicon nitride element is not reserved to the example multi-ring burner depicted in FIG. 3 and may likewise be applied to other burner configurations as envisioned by the skilled person. As shown, the silicon nitride element 50 is introduced and arranged in a central opening 52 of inner burner head 10. Use of the silicon nitride element for heating purposes obviates the need for using gas, thereby dispensing with the need for a central opening configured to introduce the gas/air mixture therein along with ports along the inner burner head's circumferential wall for the burning thereof. Accordingly, as depicted the circumferential wall 54 of inner burner head 10 lacks ports while a central opening 18 is also absent. The silicon nitride element 50 may be arranged within the central opening 52 and provided with current by means known to the skilled person. Control of the current to the silicon nitride may be affected by an appropriately located and configured single activation point comprising a switch or knob (not shown) for selectively activating at least one of the burner head and the outer burning head heat generation.

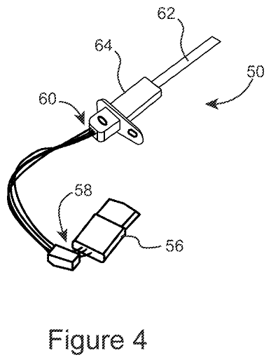

A silicon nitride element suitable for use with embodiments of the present disclosure is depicted in FIG. 4. Other arrangements for silicon nitride elements providing the output disclosed herein may also be used. As depicted, a standard electrical plug 56 is attached to first conductor end 58, the plug being appropriately configured to mate with a suitably configured socket (not shown) during assembly. Second conductor end 60 is electrically coupled to the silicon nitride material arranged in rectangular form 62 via holder 64. Appropriate mounting means 66 may be positioned proximate to and between the second conductor ends and holder 64. In operation, the flow of current to the silicon nitride 62 is selectively controlled to be in proportion to the amount of heat generated by the silicon nitride element. The low heat generated by the silicon nitride element may fall within the range of 85-95 degrees Celsius at up to 500 BTUs. Other temperature ranges may start at 70 degrees Celsius with BTU output ranging upwards from 500 BTUs to 1500 BTUs. Still other ranges and values may be selectively obtained through appropriate control of the current flowing to the silicon nitride element.

Having described some aspects of the present disclosure in detail, it will be apparent that further modifications and variations are possible without departing from the scope of the disclosure. All matter contained in the above description and shown in the accompanying drawings shall be interpreted as illustrative and not in a limiting sense.

What is claimed is:

1. A burner assembly, comprising:
a burner head having a central opening and a cap arranged above of the central opening and configured for receiving and radiating heat;
an electrical heating element arranged within the central opening and proximate to the cap, the electrical heating element configured to generate the heat in response to a flow of current; and
wherein the electrical heating element comprises a silicon nitride element.

2. The burner assembly according to claim 1, further comprising an annular burner head surrounding the burner head, the annular burner head configured to generate more heat than the burner head.

3. The burner assembly according to claim 2, wherein the electrical heating element is configured to heat the cap up to 500 BTUs.

4. The burner assembly according to claim 2, wherein the electrical heating element is configured to heat the cap within a range of 500 BTUs to 1500 BTUs.

5. The burner assembly according to claim 2, wherein the electrical heating element is configured to heat the cap to a temperature of between 85° Celsius and 95° Celsius.

6. The burner assembly according to claim 2, wherein the electrical heating element is configured to heat the cap to a temperature of between 70° Celsius and 95° Celsius.

7. The burner assembly according to claim 1, wherein the electrical heating element is configured to operate at a 0.5 amperes.

8. The burner assembly according to claim 2, wherein the annular burner head is configured to receiving a gas/air mixture and the electrical heating element is configured to receive the current, whereby a flow of at least one of the gas/air mixture and the current is controllable from a single activation point.

9. A method for providing a burner assembly, comprising the steps of:
arranging a cap above a central opening of a burner head, the cap configured for receiving and radiating heat;
arranging an electrical heating element within the central opening proximate to the cap, the electrical heating element configured to generate the heat in response to a flow of current; and
wherein the electrical heating element comprises a silicon nitride element.

10. The method according to claim 9, further comprising the steps of arranging an annular burner head surrounding the burner head, the annular burner head configured to generate more heat than the burner head.

11. The burner according to claim 10, wherein the electrical heating element is configured to heat the cap up to 500 BTUs.

12. The burner according to claim 10, wherein the electrical heating element is configured to heat the cap within a range of 500 BTUs to 1500 BTUs.

13. The burner according to claim 10, wherein the electrical heating element is configured to heat the cap to a temperature of between 85° Celsius and 95° Celsius.

14. The burner according to claim 10, wherein the electrical heating element is configured to heat the cap to a temperature of between 70° Celsius and 95° Celsius.

15. The burner according to claim 9, wherein the electrical heating element is configured to operate at a 0.5 amperes.

16. The burner according to claim 10, wherein the annular burner head is configured to receiving a gas/air mixture and the electrical heating element is configured to receive the current, whereby a flow of at least one of the gas/air mixture and the current is controllable from a single activation point.
